(19) United States
(12) Patent Application Publication
(10) Pub. No.: US 2015/0338837 A1
(43) Pub. Date: Nov. 26, 2015

(54) METHOD AND DEVICE FOR MANAGING AND CONFIGURING FIELD DEVICES IN AN AUTOMATION INSTALLATION

(71) Applicant: ABB Technology AG, Zurich (CH)

(72) Inventors: Dirk WAGENER, Stadthagen (DE); Christoph WELTE, Neu-Ulm (DE); Marcus HEEGE, Kaisersesch (DE); Wolfgang MAHNKE, Hettenleidelheim (DE); Marko SCHLÜTER, Espelkamp (DE)

(73) Assignee: ABB Technology AG, Zurich (CH)

(21) Appl. No.: 14/717,333

(22) Filed: May 20, 2015

(30) Foreign Application Priority Data
May 20, 2014 (DE) 102014007386.6

(51) Int. Cl. G05B 19/05

(52) U.S. Cl. CPC G05B 19/056; G05B 2219/13004

(57) ABSTRACT

A method and a device are disclosed for managing and configuring field devices in an automation installation with a configuration tool which is designed to physically detect a field device in the automation installation, to logically incorporate the field device in the automation installation and to configure the field device in the automation installation, the configuration tool including a predefined first field-device-specific information packet which at least partially describes the functions and data of the field device. For repeated performance of actions for devices and displays which are already being used, a permanent device overview includes all devices which are already being used, and a temporary display overview includes all displays which are already being used for a device, the temporary display overview being displayed on an individual-device basis in each case when a device is selected from the permanent device overview.

### RELATED APPLICATION(S)

This application claims priority under 35 U.S.C. §119 to German Patent Application No. 102014007386.6, filed on May 20, 2014, the entire content of which is hereby incorporated by reference in its entirety.

### FIELD

The disclosure relates to a method and a device for managing and configuring field devices in an automation installation. The disclosure can be used, for example, in process automation or machine control for controlling processes and/or installation components.

### BACKGROUND INFORMATION

Automation systems for controlling a technical process or a technical installation can include a control device (PLC) which can be integrated in a group of a multiplicity of intelligent electrical devices, also called Intelligent Electronic Devices (IED). Intelligent electronic devices can be microprocessor-based devices, for example, protective and control devices, motor protective devices, intelligent switches and voltage regulators, frequency converters, pressure and temperature measuring transducers, flowmeters and actuators.

The article “FDI Device Integration—Best of Both Worlds”, atp edition June/2010, pages 16 to 19, discloses the practice of integrating field devices in an automation installation using the FDI concept (Field Device Integration IEC-62769). The basis of this concept is the provision of information for configuring field devices in a device-specific FDI packet. This FDI packet can include a firmly predefined amount of information which can include a device definition, business logic, a user interface description and user interface plug-ins. The device definition can include management information and the device model. The business logic describes the communication logic for the device and can be used to ensure consistency of the device model. The user interface description describes the presentation of the device parameters and device functions. The user interface plug-ins are programmed components of interface portions for displaying the device parameters and functions.

When configuring field devices by EDD (electronic device description) technology IEC 61804, a device manufacturer provides an EDD which can include information relating to the communication with the device, the business logic and the user interfaces, for example, which input masks should be displayed for a user. The business logic can include, for example, when which parameters can be written.

FDI technology uses these EDD mechanisms and provides the concept of the FDI package which, in addition to an EDD, can also include other information such as a user handbook or else so-called UIPs (user interface plug-in) which provide further user interfaces in other technologies, for example .NET assemblies, which, in contrast to EDD-based user interfaces, contain programmed code compiled for a component.

FDI packets can be created by device manufacturers and can be used by system manufacturers to integrate and configure the devices from the device manufacturers in their system.

In addition to an individual user element having different parameters, graphs and other elements, new windows and dialogs can also be defined in the EDD. For example, a host can have certain freedoms and can display a plurality of menus defined in the EDD in different windows at the same time, for example, or else user interfaces of different device entities.

Known EDD host systems can either restrict the number of windows or open an arbitrary number of windows for the different devices. In this case, the overview of the assignment of the windows to the devices is lost.

In addition, the EDD specification can allow an input context to be defined, which input context can include changes to a device configuration which have already been made by the user at the interface but have not yet been written to the device or the offline configuration. According to the specification, in this case, different windows and dialogs can work on different input contexts of the same device. This concept can make it more difficult for a user to assign the windows not only to the device but also to a particular input context.

According to known art, EDD host systems display the windows described in the EDD as windows of the application, with the result that the user can compare a plurality of window contents with one another. However, the windows can be assigned to a particular device entity only with difficulty and can be assigned to a particular input context of this device entity with even more difficulty. If a user wishes to use or reject an input context, it can be difficult to discern which windows are affected thereby.

In such a programming tool, information relating to the devices can be visualized and functions, such as parameter setting, can be executed. For this purpose, a device is first to be selected by the user from a multiplicity of devices.

A method, a device and a computer program for creating a plan for an operating device of an automation component are known from DE 10 2004 010 203 B4, in the case of which the devices are provided for selection in a hierarchical tree structure. In this case, devices and the functions thereof can also be indicated in a project bar for quick access. In the case of a multiplicity of devices and functions thereof to be handled, this representation can be already unclear for a small number of devices and functions.

### SUMMARY

A method is disclosed for managing and configuring field devices in an automation installation with a configuration tool configured to physically detect a field device in the automation installation, to logically incorporate the field device in the automation installation, and to configure the field device in the automation installation, the configuration tool including a predefined first field-device-specific information packet which at least partially describes functions and data of the field device, the method comprising: for repeated performance of actions for devices and displays which are already being used, retaining device which is being used in a device overview for repeated access, each display which belongs to a device being added to the display overview of the device upon a first use of the display; and when the device is selected in the device overview, all displays of the selected device which have already been used are provided to the display overview of the selected device for the selection of a desired display.

A device is disclosed for managing and configuring field devices in an automation installation, the device comprising: a configuration tool which is configured to physically detect a field device in the automation installation, to logically incorporate the field device in the automation installation, and to configure the field device in the automation installation, the configuration tool including a predefined first field-device-specific information packet which at least partially describes functions and data of the field device; and wherein the configuration tool is configured to provide a permanent device overview and a temporary function overview for repeated performance of actions for devices and displays which are already being used, the permanent device overview including all devices which are already being used and the temporary display overview including all displays which are already being used for a device, the temporary display overview being displayed on an individual-device basis in each case when a device is selected from the permanent device overview.

### BRIEF DESCRIPTION OF THE DRAWINGS

The disclosure is explained below with reference to the exemplary embodiments shown in the drawing. In the drawing:

FIG. 1 is an illustration of the screen of a configuration tool on which a device overview is permanently displayed in accordance with an exemplary embodiment.

### DETAILED DESCRIPTION

In accordance with exemplary embodiments, a method and a device are disclosed for managing and configuring field devices in an automation installation, the clarity of which can be maintained, even in the case of a multiplicity of devices and functions being handled simultaneously.

The disclosure is based at least in part on managing and configuring field devices in an automation installation with a configuration tool which can be designed to physically detect a field device in the automation installation, to logically incorporate it in the automation installation and to configure it in the automation installation, the configuration tool resorting for this purpose to a predefined first field-device-specific information packet which at least partially describes the functions and data of the field device.

According to the disclosure in terms of an exemplary method, what is provided is that, for repeated performance of actions for devices and displays thereof which are already being used, each device which is being used is kept in a device overview for repeated access, all displays which belong to a device being added to a display overview of the respective device in the case of the respective first use of the displays and, when a device is selected in the device overview, all of the displays of the selected device which have already been used are provided to the display overview which belongs to the device for the selection of the display which is sought.

According to the disclosure in terms of an exemplary device, what is provided is that the configuration tool can include a permanent device overview and a temporary display overview for repeated performance of actions for devices and displays thereof which are already being used, the permanent device overview can include all devices which are already being used and the temporary display overview can include all displays which are already being used for a device and the temporary display overview being displayed on an individual-device basis in each case when a device is selected from the permanent device overview.

In accordance with an exemplary embodiment, the permanent device overview can remain clear even for a relatively large number of devices which are being handled at the same time. This clarity is supported by the device-related temporary display overviews which in each case are displayed on an individual-device basis only when a device is selected from the permanent device overview. That means that, in addition to the permanent device overview, only a single temporary display overview is ever displayed and, for example, only when a device has been selected from the permanent device overview.

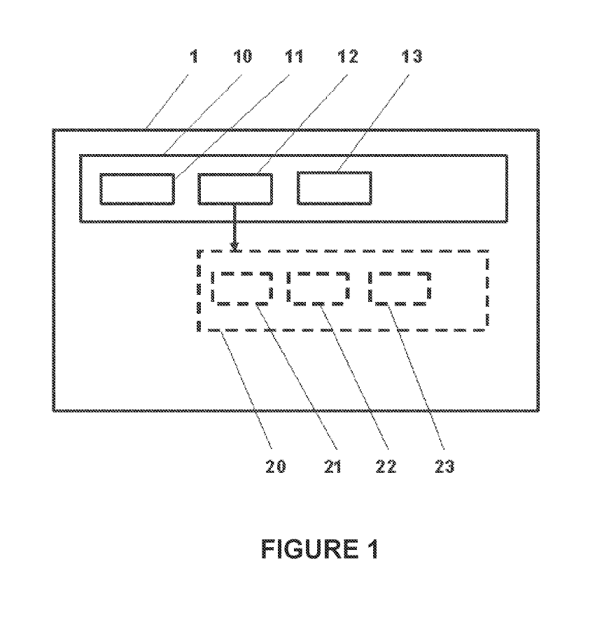

The disclosure is explained in more detail below using an exemplary embodiment. FIG. 1 is an exemplary illustration of the screen of a configuration tool 1 on which a device overview 10 can be permanently displayed. For example, the device overview 10 can be designed to be bar-shaped.

To begin with, the device overview 10 is empty. Once a device 11, 12, 13 has been selected and called in the configuration tool 1 for processing, it is added to the device overview 10 and kept in the device overview 10 for repeated performance of actions. Proceeding from the device overview 10, the user can now perform actions once more for the device 11, 12, 13 or have information displayed to them. Owing to the device overview 10, the user therefore does not need to search again for the devices 11, 12, 13 which have already been called but instead the user finds the devices at a central point in the user interface of the configuration tool 1 in a simple and intuitive manner.

For each device 11, 12, 13, various displays 21, 22, 23 for handling various device functions can be called. A display overview 20, which can be temporarily displayed, can be associated with each device 11, 12, 13 in the device overview 10.

In accordance with an exemplary embodiment, to begin with, the display overview 20 can be empty. Once a display 21, 22, 23 of a device 11, 12, 13 is called for handling, the called display 21, 22, 23 can be added to the display overview 20 of the respective device 11, 12, 13 and can be kept in the display overview 20 for repeated performance of actions.

During the processing of displays 21, 22, 23 of devices 11, 12, 13, the display overview 20 can be hidden. When a device 11, 12, 13 is selected from the permanently displayed device overview 10, the device-specific display overview 20 can be temporarily displayed for selecting a display 21, 22, 23.

If a plurality of displays 21, 22, 23 for one device 11, 12, 13 are open, the device overview 10 can display the displays 21, 22, 23 to the user so that the user can then select one of the displays 21, 22, 23. For this purpose, the user moves an indicator instrument, for example, a computer mouse, onto the device object 11, 12, 13 in the device overview 10 and the device overview 10 superimposes a preview of the open and hence available displays 21, 22, 23. By selection and activation, for example, by a click with the computer mouse, on the appropriate display 21, 22, 23, the display can be switched to be visible on the screen of the configuration tool 1. In the case of modern touch devices, the preview display can be provided by a touch on the appropriate device object 11, 12, 13 in the device overview 10. A drag-and-drop operation can also be used.

In FIG. 1, the device 12 can be selected and the associated display overview 20 can be displayed.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 configuration tool
10 device overview
11, 12, 13 device
20 display overview
21, 22, 23 display

What is claimed is:

1. A method for managing and configuring field devices in an automation installation with a configuration tool configured to physically detect a field device in the automation installation, to logically incorporate the field device in the automation installation, and to configure the field device in the automation installation, the configuration tool including a predefined first field-device-specific information packet which at least partially describes functions and data of the field device, the method comprising:
for repeated performance of actions for devices and displays which are already being used, retaining device which is being used in a device overview for repeated access, each display which belongs to a device being added to the display overview of the device upon a first use of the display; and
when the device is selected in the device overview, all displays of the selected device which have already been used are provided to the display overview of the selected device for the selection of a desired display.

2. The method of claim 1, comprising:
selecting the device and adding the device to the device overview.

3. The method of claim 2, comprising:
displaying various displays for each device, each of the various displays configured to handle various functions of each device.

4. The method of claim 3, comprising:
temporarily displaying a display overview for each device in the device overview.

5. The method of claim 1, comprising:
hiding the display overview during a processing of the display overview of each device.

6. The method of claim 1, comprising:
selecting the device from a permanently displayed device overview; and
temporarily displaying a device-specific display overview.

7. The method of claim 1, comprising:
selecting the device from a plurality of displays on the configuration tool by moving an indicator instrument onto a device object in the device overview.

8. The method of claim 1, comprising:
superimposing a preview of open devices on the device overview; and
displaying available displays on the device overview by selecting and activating the available displays.

9. A device for managing and configuring field devices in an automation installation, the device comprising:
a configuration tool which is configured to physically detect a field device in the automation installation, to logically incorporate the field device in the automation installation, and to configure the field device in the automation installation, the configuration tool including a predefined first field-device-specific information packet which at least partially describes functions and data of the field device; and
wherein the configuration tool is configured to provide a permanent device overview and a temporary function overview for repeated performance of actions for devices and displays which are already being used, the permanent device overview including all devices which are already being used and the temporary display overview including all displays which are already being used for a device, the temporary display overview being displayed on an individual-device basis in each case when a device is selected from the permanent device overview.

10. The device of claim 9, wherein the permanent device overview is bar-shaped.
